(19) United States
(12) Patent Application Publication
(10) Pub. No.: US 2007/0053441 A1
(43) Pub. Date: Mar. 8, 2007

(54) Method and apparatus for update step in video coding using motion compensated temporal filtering

(76) Inventors: Xianglin Wang, Santa Clara, CA (US); Marta Karczewicz, Irving, TX (US); Yiliang Bao, Coppell, TX (US); Justin Ridge, Sachse, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/479,126

(22) Filed: Jun. 29, 2006

Related U.S. Application Data
(60) Provisional application No. 60/695,648, filed on Jun. 29, 2005.

(51) Int. Cl. H04N 11/04

(52) U.S. Cl. 375/240.24

(57) ABSTRACT

The present invention provides a method and module for performing the update operation in motion compensated temporal filtering for video coding. The update operation is performed according to coding blocks in the prediction residue frame. Depending on macroblock mode in the prediction step, a coding block can have different sizes. Macroblock modes are used to specify how a macroblock is segmented into blocks. In the prediction step, the reverse direction of the motion vectors is used directly as an update motion vector and therefore no motion vector derivation process is performed. Motion vectors that significantly deviate from their neighboring motion vectors are considered not reliable and excluded from the update step. An adaptive filter is used in interpolating the prediction residue block for the update operation. The adaptive filter is an adaptive combination of a short filter and a long filter.

### CROSS REFERENCES TO RELATED APPLICATIONS

The patent application is based on and claims priority to a pending U.S. Provisional Patent Application Ser. No. 60/695,648, filed Jun. 29, 2005.

### FIELD OF THE INVENTION

The present invention relates generally to video coding and, specifically, to video coding using motion compensated temporal filtering.

### BACKGROUND OF THE INVENTION

For storing and broadcasting purposes, digital video is compressed, so that the resulting, compressed video can be stored in a smaller space.

Digital video sequences, like ordinary motion pictures recorded on film, comprise a sequence of still images, and the illusion of motion is created by displaying the images one after the other at a relatively fast frame rate, typically 15 to 30 frames per second. A common way of compressing digital video is to exploit redundancy between these sequential images (i.e. temporal redundancy). In a typical video at a given moment, there exists slow or no camera movement combined with some moving objects, and consecutive images have similar content. It is advantageous to transmit only the difference between consecutive images. The difference frame, called prediction error frame Eₙ, is the difference between the current frame Iₙ and the reference frame Pₙ. The prediction error frame is thus given by
Eₙ(x,y)=Iₙ(x,y)−Pₙ(x,y).
Where n is the frame number and (x, y) represents pixel coordinates. The predication error frame is also called the prediction residue frame. In a typical video codec, the difference frame is compressed before transmission. Compression is achieved by means of Discrete Cosine Transform (DCT) and Huffman coding, or similar methods.

Since video to be compressed contains motion, subtracting two consecutive images does not always result in the smallest difference. For example, when camera is panning, the whole scene is changing. To compensate for the motion, a displacement (Δx(x, y), Δy(x, y)) called motion vector is added to the coordinates of the previous frame. Thus prediction error becomes
Eₙ(x,y)=Iₙ(x,y)−Pₙ(x+Δx(x, y),y+Δy(x, y)).

In practice, the frame in the video codec is divided into blocks and only one motion vector for each block is transmitted, so that the same motion vector is used for all the pixels within one block. The process of finding the best motion vector for each block in a frame is called motion estimation. Once the motion vectors are available, the process of calculating Pₙ(x+Δx(x, y),y+Δy(x, y)) is called motion compensation and the calculated item Pₙ(x+Δx(x, y),y+Δy(x, y)) is called motion compensated prediction.

In the coding mechanism described above, reference frame Pₙ can be one of the previously coded frames. In this case, Pₙ is known at both the encoder and decoder. Such coding architecture is referred to as closed-loop.

Pₙ can also be one of original frames. In that case the coding architecture is called open-loop. Since the original frame is only available at the encoder but not the decoder, there may be drift in the prediction process with the open-loop structure. Drift refers to the mismatch (or difference) of prediction Pₙ(x+Δx(x, y), y+Δy(x, y)) between the encoder and the decoder due to different frames used as reference. Nevertheless, open-loop structure becomes more and more often used in video coding, especially in scalable video coding due to the fact that open loop structure makes it possible to obtain a temporally scalable representation of video by using lifting-steps to implement motion compensated temporal filtering (i.e. MCTF).

FIGS. 1a and 1b show the basic structure of MCTF using lifting-steps, showing both the decomposition and the composition process for MCTF using a lifting structure. In these figures, Iₙ and Iₙ₊₁ are original neighboring frames.

The lifting consists of two steps: a prediction step and an update step. They are denoted as P and U respectively in FIGS. 1a and 1b. FIG. 1a is the decomposition (analysis) process and FIG. 1b is the composition (synthesis) process. The output signals in the decomposition and the input signals in the composition process are H and L signals. H and L signal are derived as follows:
H=Iₙ₊₁−P(Iₙ)
L=Iₙ+U(H)
The prediction step P can be considered as the motion compensation. The output of P, i.e. P(Iₙ), is the motion compensated prediction. In FIG. 1(a), H is the temporal prediction residue of frame Iₙ₊₁ based on the prediction from frame Iₙ. H signal generally contains the temporal high frequency component of the original video signal. In the update step U, the temporal high frequency component in H is fed back to frame Iₙ in order to produce a temporal low frequency component L. For that reason, H and L are called temporal high band and low band signal, respectively.

In the composite process shown in FIG. 1b, the reconstruction frames I′ₙ and I′ₙ₊₁ are derived through the following operation:
I′ₙ=L−U(H)
I′ₙ₊₁=H+P(I′ₙ)
If signals L and H remain unchanged between the decomposition and composition processes as shown in FIGS. 1a and 1b, then Iₙ′ and Iₙ₊₁′ would be exactly the same as Iₙ and Iₙ₊₁ respectively. In that case, perfect reconstruction can be achieved with such lifting steps.

The structure shown in FIGS. 1a and 1b can also be cascaded so that a video sequence can be decomposed into multiple temporal levels. As shown in FIG. 2, two level lifting steps are performed. The temporal low band signal at each decomposition level can provide temporal scalability.

In MCTF, the prediction step is essentially a general motion compensation process, except that it is based on an open-loop structure. In such a process, a compensated prediction for the current frame is produced based on best-estimated motion vectors for each macroblock. Because motion vectors usually have sub-pixel precision, sub-pixel interpolation is needed in motion compensation. Motion vectors can have a precision of ¼ pixel. In this case, possible positions for pixel interpolation are shown in FIG. 3. FIG. 3 shows the possible interpolated pixel positions down to a quarter pixel. In FIG. 3, A, E, U and Y indicate original integer pixel positions, and c, k, m, o and w indicate half pixel positions. All other positions are quarter-pixel positions.

Typically, values at half-pixel positions are obtained by using a 6-tap filter with impulse response (1/32, −5/32, 20/32, 20/32, −5/32, 1/32). The filter is operated on integer pixel values, along both the horizontal direction and the vertical direction where appropriate. For decoder simplification, 6-tap filter is generally not used to interpolate quarter-pixel values. Instead, the quarter positions are obtained by averaging an integer position and its adjacent half-pixel positions, and by averaging two adjacent half-pixel positions as follows:

b=(A+c)/2, d=(c+E)/2, f=(A+k)/2, g=(c+k)/2, h=(c+m)/2, i=(c+o)/2, j=(E+o)/2 l=(k+m)/2, n=(m+o)/2, p=(U+k)/2, q=(k+w)/2, r=(m+w)/2, s=(w+o)/2, t=(Y+o)/2 v=(w+U)/2, x=(Y+w)/2

An example of motion prediction is shown in FIG. 4a. In FIG. 4a, Aₙ represents a block in frame Iₙ and Aₙ₊₁ represents a block with the same position in frame Iₙ₊₁. Assuming Aₙ is used to predict a block Bₙ₊₁ in frame Iₙ₊₁ and the motion vector used for prediction is (Δx, Δy) as indicated in the FIG. 4a. Depending on the motion vector (Δx, Δy), Aₙ can be located at a pixel or a sub-pixel position as shown in FIG. 3. If Aₙ is located at a sub-pixel position, then interpolation of values in Aₙ is needed before it can be used as a prediction to be subtracted from block Bₙ₊₁.

### SUMMARY OF THE INVENTION

The present invention provides efficient methods for performing the update step in MCTF for video coding.

The update operation is performed according to coding blocks in the prediction residue frame. Depending on macroblock mode in the prediction step, a coding block can have different sizes. Macroblock modes are used to specify how a macroblock is segmented into blocks. For example, a macroblock may be segmented into a number of blocks as specified by a selected macroblock mode and the number can be one or more. In the update step, the reverse direction of the motion vectors used in the prediction step is used directly as an update motion vector and therefore no motion vector derivation process is performed.

Motion vectors that significantly deviate from their neighboring motion vectors are considered not reliable and excluded from the update step.

An adaptive filter is used in interpolating the prediction residue block for the update operation. The adaptive filter is an adaptive combination of a short filter (e.g. bilinear filter) and a long filter (e.g. 4 tap FIR filter). The switch between the short filter and the long filter is based on the energy level of the corresponding prediction residue block. If the energy level is high, the short filter is used for interpolation. Otherwise, the long filter is used.

For each prediction residue block, a threshold is adaptively determined to limit the maximum amplitude of the residue in the block before it is used as an update signal. In determining the threshold, one of the following mechanisms can be used:
In general, based on the energy level of the prediction residue block, the higher the energy level is, the lower the selected threshold becomes.
Based on a block-matching factor, an indicator is used to indicate how well the block is matched or predicted during motion compensation in the prediction step. If the block is matched well, a higher threshold may be used in the update step in limiting the maximum amplitude of the residue block. To obtain the block-matching factor, one of the following methods can be used.
Based on the ratio of the variance of the corresponding block to be updated and the energy level of the prediction residue block, if the ratio is high, it is assumed that the block matching is relatively good.
Perform a high-pass filtering operation on the block to be updated. Then the amplitude (i.e. absolute value) of each filtered pixel in the block is compared against the amplitude of the corresponding prediction residue pixel. It is assumed that the prediction residue pixel should have a smaller amplitude than the corresponding filtered pixel if the block is well matched in the prediction step. The percentage of prediction residue pixels in the block that meet the above assumption can be used as block-matching factor.

Thus, the first aspect of the present invention is the method of encoding and decoding a video sequence having a plurality of video frames wherein a macroblock of pixels in a video frame is segmented based on a macroblock mode. The method comprises an update operation partially based on a reverse direction of motion vectors and a prediction operation.

The second aspect of the present invention is the encoding module and the decoding module having a plurality of processors for carrying out the method of encoding and decoding as described above.

The third aspect of the present invention is an electronic device, such as a mobile terminal, having the encoding module and/or the decoding module as described above.

The fifth aspect of the present invention is a software application product having a memory for storing a software application having program codes to carry out the method of encoding and/or decoding as described above.

The present invention provides an efficient solution for MCTF update step. It not only simplifies the update step interpolation process, but also eliminates the update motion vector derivation process. By adaptively determining a threshold to limit the prediction residue, this method does not require the threshold values to be saved in bit-stream.

### BRIEF DESCRIPTION OF THE DRAWINGS

FIG. 1a shows the decomposition process for MCTF using a lifting structure.

FIG. 1b shows the composition process for MCTF using the lifting structure.

FIG. 2 shows a two-level decomposition process for MCTF using the lifting structure.

FIG. 3 shows the possible interpolated pixel positions down to a quarter-pixel.

FIG. 4a shows an example of the relationship of associated blocks and motion vectors that are used in the prediction step.

FIG. 4b shows the relationship of associated blocks and motion vectors that are used in the update step.

FIG. 5 shows one process for update motion vector derivation.

FIG. 6 shows the partial pixel difference of locations for blocks involved in the update step from those in the prediction step.

FIG. 7 is a block diagram showing the MCTF decomposition process.

FIG. 8 is a block diagram showing the MCTF composition process.

FIG. 9 shows a block diagram of an MCTF-based encoder.

FIG. 10 shows a block diagram of an MCTF-based decoder.

FIG. 11 is a block diagram showing the MCTF decomposition process with a motion vector filter module.

FIG. 12 is a block diagram showing the MCTF composition process with a motion vector filter module.

FIG. 13 shows the process for adaptive interpolation in MCTF update step based on the energy level of prediction residue block.

FIG. 14 shows the process for adaptive control on the update signal strength based on the energy level of prediction residue block.

FIG. 15 shows the process for adaptive control on the update signal strength based on a block-matching factor.

FIG. 16 is a flowchart for illustrating part of the method of encoding, according to one embodiment of the present invention.

FIG. 17 is a flowchart for illustrating part of the method of decoding, according to one embodiment of the present invention.

FIG. 18 is a block diagram of an electronic device which can be equipped with one or both of the MCTF-based encoding and decoding modules, according to the present invention.

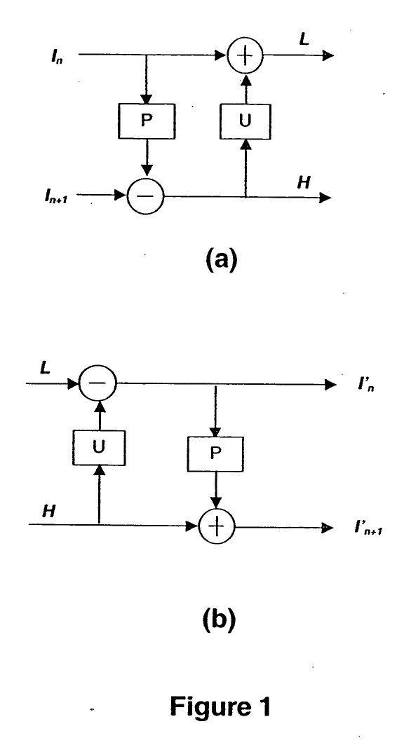

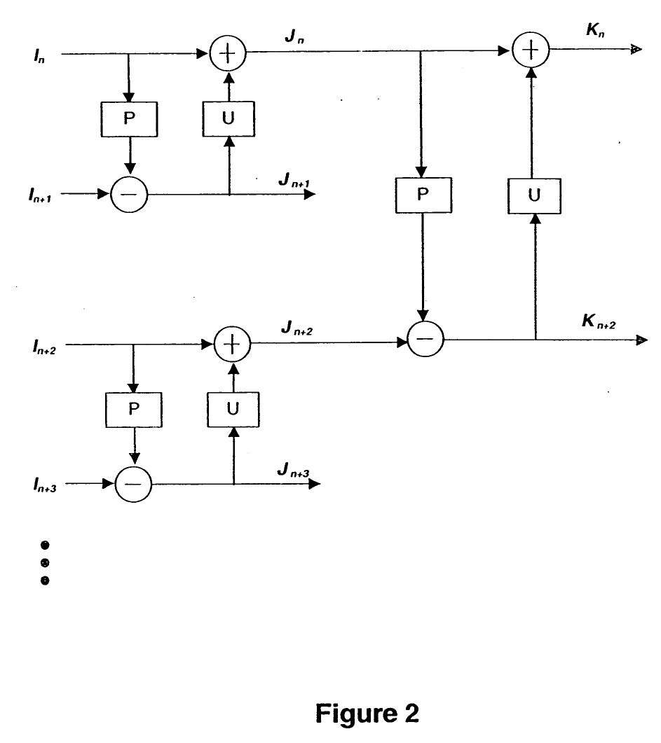

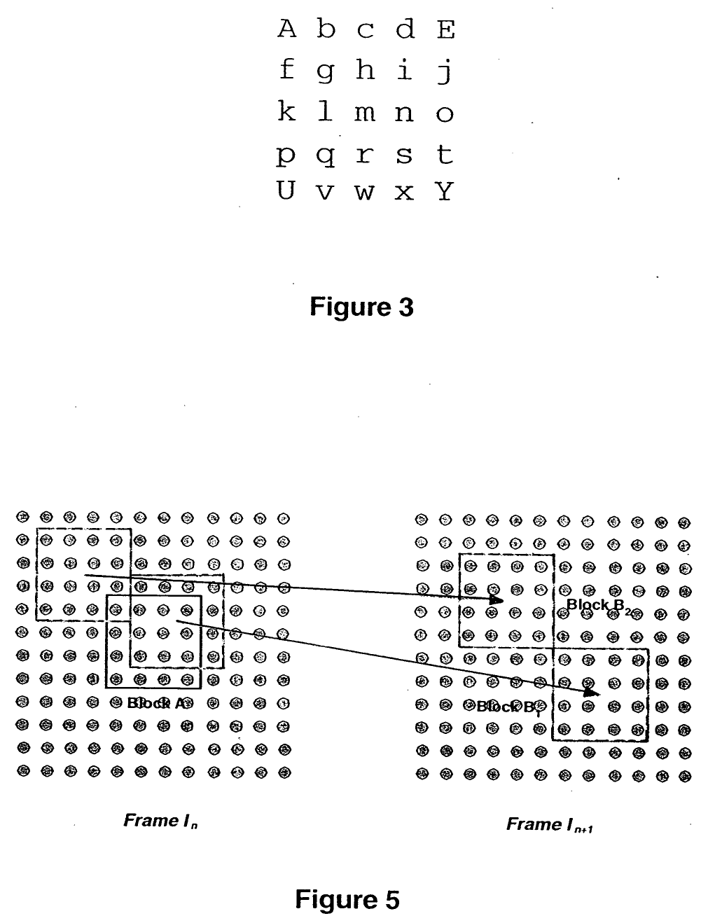

### DETAILED DESCRIPTION OF THE INVENTION

Both the decomposition and composition processes for motion compensated temporal filtering (MCTF) can use a lifting structure. The lifting consists of a prediction step and an update step.

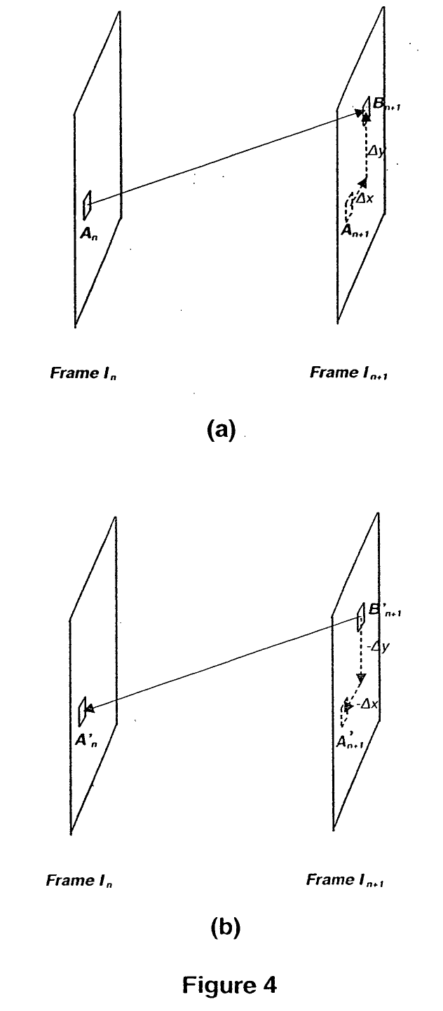

In the update step, the prediction residue at block Bₙ₊₁ can be added to the reference block along the reverse direction of the motion vectors used in the prediction step. If the motion vector is (Δx, Δy) (see FIG. 4a), then its reverse direction can be expressed as (−Δx, −Δy) which may also be considered as a motion vector. As such, the update step also includes a motion compensation process. The prediction residue frame obtained from the prediction step can be considered as being used as a reference frame. The reverse directions of those motion vectors in the prediction step are used as motion vectors in the update step. With such reference frame and motion vectors, a compensated frame can be constructed. The compensated frame is then added to frame Iₙ in order to remove some of the temporal high frequencies in frame Iₙ.

The update process is performed only on integer pixels in frame Iₙ. If Aₙ is located at a sub-pixel position, its nearest integer position block A′ₙ is actually updated according to the motion vector (−Δx, −Δy). This is shown in FIG. 4b. In that case, there is a partial pixel difference between location of block Aₙ and A′ₙ. According to the motion vector (−Δx, −Δy), the reference block for A′ₙ in the update step (denoted as B′ₙ₊₁) is not located at an integer pixel position either. However, there will be the same partial pixel difference between the locations of block Bₙ₊₁ and block B′ₙ₊₁. For that reason, interpolation is needed for obtaining the prediction residue at block B′ₙ₊₁. Thus, interpolation is generally needed in the update step whenever the motion vector (−Δx, −Δy) does not have an integer pixel displacement for either horizontal or vertical direction.

The update step can be performed block by block with a block size of 4×4 in the frame to be updated. For each 4×4 block in the frame, a good motion vector for updating the block may be derived by scanning all the motion vectors used in the prediction step and selecting the motion vector that has the maximum cover ratio of the current 4×4 block. This is shown in FIG. 5. In FIG. 5, frame Iₙ is used to predict frame Iₙ₊₁. As indicated, both the reference block of block B₁ and block B₂ cover some area of the current 4×4 block A that is to be updated. In this example, since the reference block of block B₁ has a larger covering area, the motion vector of block B₁ is selected and its reverse direction is used as the update motion vector for block A. Such a process is referred to as an update motion vector derivation process and the motion vector so derived is herein referred to as an update motion vector. Using this method, once update motion vectors are derived for the whole frame, the regular block-based motion compensation process used in the prediction step can be directly applied to the motion compensation process in the update step.

In one embodiment of the present invention, the update operation is performed according to coding blocks in the prediction residue frame. Depending on the macroblock mode in the prediction step, a coding block can have different size, e.g. from 4×4 up to 16×16.

As shown in FIG. 4a, in the prediction step, frame Iₙ is used to predict frame Iₙ₊₁. After the subtraction of motion compensated prediction in the prediction step, frame Iₙ₊₁ contains only the prediction residue. In the update step, the update operation is performed according to each coding block in frame Iₙ₊₁. For example, when block Bₙ₊₁ is to be processed in the update step, its reference block in the prediction step, Aₙ, is first located according to the motion vector (Δx, Δy) which is used in prediction step. If Aₙ is located at sub-pixel position, its nearest integer position block A′ₙ is actually updated. The update operation is essentially a motion compensation process, in which the reverse direction of the motion vector used in the prediction step is used as an update motion vector. In the example shown in FIG. 4b, the update motion vector for block A′ₙ is (−Δx, −Δy).

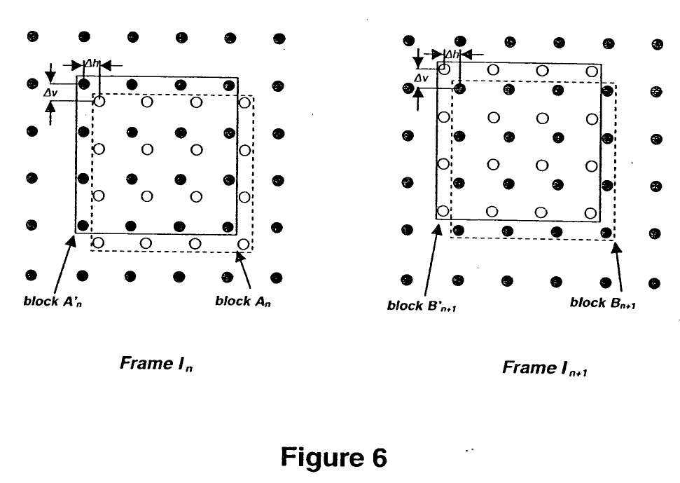

Now that the position of block A′ₙ and the update motion vector (−Δx, −Δy) are both available, the reference block for block A′ₙ in the update step can also be located. This is shown in FIG. 4b. Since there is a partial pixel difference between locations of block Aₙ and block A′ₙ according to the motion vector (−Δx, −Δy), the reference block for A′ₙ in the update step, or B′ₙ₊₁, should have a location that is shifted by the same amount of difference from the position of block Bₙ₊₁ as well. This situation is further illustrated in FIG. 6. In FIG. 6, solid dots represent integer pixel locations and hollow dots represent sub-pixel locations. Blocks indicated with dashed boundaries and solid boundaries are involved in the prediction step and the update step, respectively. The partial pixel difference of location between block Aₙ and block A′ₙ is (Δh, Δv). Accordingly, there is the same amount of partial pixel difference between the location of block Bₙ₊₁ and block B′ₙ₊₁. Because block B′ₙ₊₁ is located at partial pixel position, prediction residues at block B′ₙ₊₁ are first interpolated from the neighboring prediction residues and then used to update the pixels at block A′ₙ.

In sum, each coding block Bₙ₊₁ in prediction residue frame is processed in the following procedures:
1) Locate its reference block Aₙ used in the prediction step.
2) Locate the reference block's nearest integer position block A′ₙ. A′ₙ is the same as Aₙ when Aₙ has an integer pixel location.
3) Use the reverse direction of the motion vector of block Bₙ₊₁ in the prediction step as the update motion vector for block A′ₙ. Based on the location of block A′ₙ and the update motion vector, locate the position of the corresponding reference block B′ₙ₊₁ for block A′ₙ.
4) Obtain the prediction residue at block B′ₙ₊₁ and use it to update block A′ₙ.

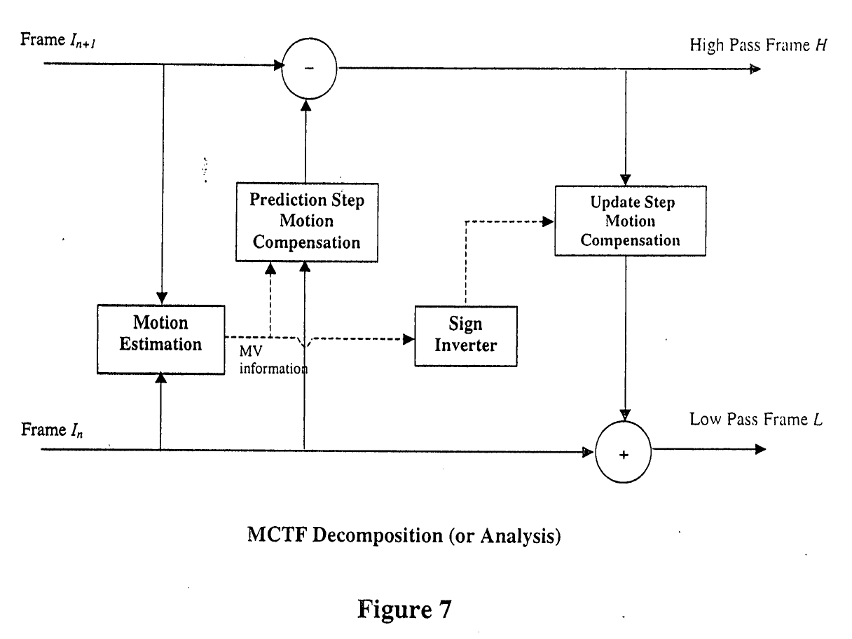

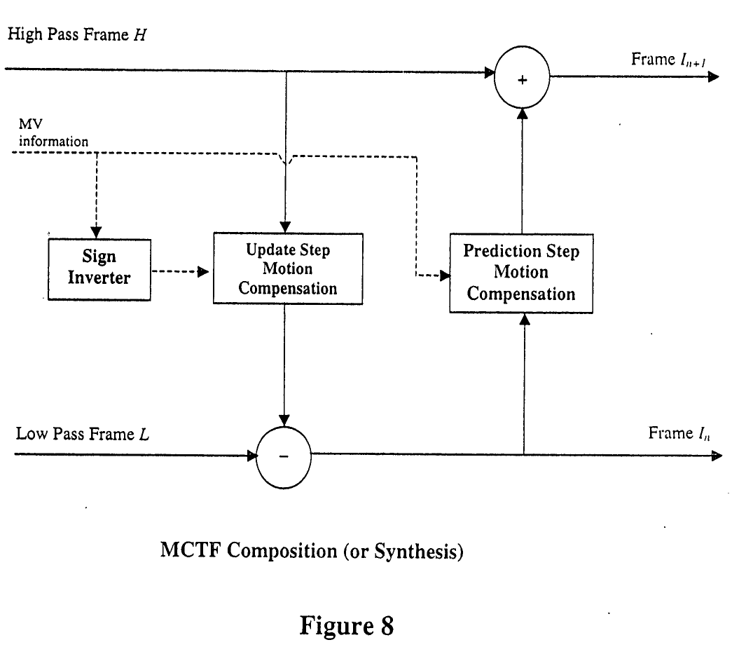

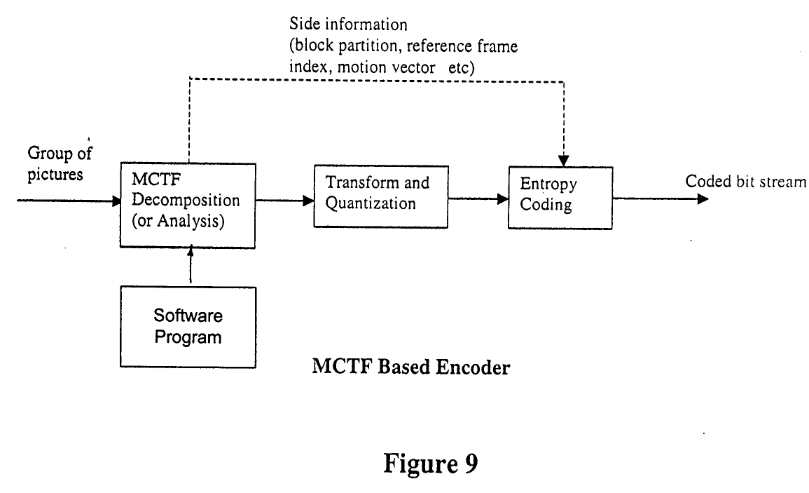

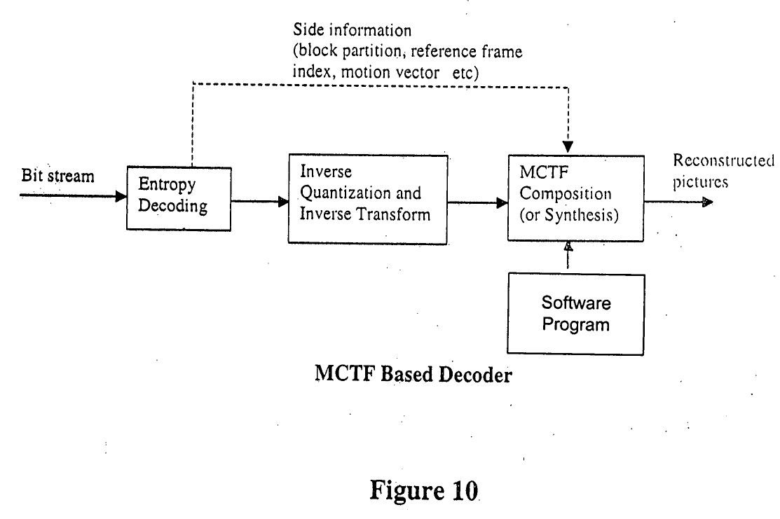

According to one embodiment of the present invention, the block diagrams for MCTF decomposition (or analysis) and MCTF composition (or synthesis) are shown in FIG. 7 and FIG. 8, respectively. With the incorporation of MCTF module, the encoder and decoder block diagrams are shown in FIG. 9 and FIG. 10, respectively. Because the prediction step motion compensation process is needed whether MCTF technique is used or not, the additional module is required with the incorporation of MCTF for the update step motion compensation process. The sign inverter in FIGS. 7 and 8 is used to change the sign of motion vector components to obtain the inverse direction of the motion vector.

FIG. 9 shows a block diagram of an MCTF-based encoder, according to one embodiment of the present invention. The MCTF Decomposition module includes both the prediction step and the update step. This module generates the prediction residue and some side information including block partition, reference frame index, motion vector, etc. Prediction residue is transformed, quantized and then sent to Entropy Coding module. Side information is also sent to Entropy Coding module. Entropy Coding module encodes all the information into compressed bitstream. The encoder also includes a software program module for carrying out various steps in the MCTF decomposition processes.

FIG. 10 shows a block diagram of an MCTF-based decoder, according to one embodiment of the present invention. Through Entropy Decoding module, a bitstream is decompressed, which provides both the prediction residue and side information including block partition, reference frame index and motion vector, etc. Prediction residue is then de-quantized, inverse-transformed and then sent to MCTF Composition module. Through MCTF composition process, video pictures are reconstructed. The decoder also includes a software program module for carrying out various steps in the MCTF composition processes.

In the above-described process, pixels to be updated are not grouped in 4×4 blocks. Instead, they are grouped according to the exact block partition and motion vector it is associated with.

Removing Outlier or Unreliable Motion Vectors from Update Step

In order to improve the coding performance and to further simplify the update step operation, a motion vector filtering process can be incorporated for the update step in MCTF. Motion vectors that are too much different from their neighboring motion vectors can be excluded from the update operation.

There are different ways in filtering motion vectors for this purpose. One way is to check the differential motion vector of each coding block in the prediction residue frame. The differential motion vector is defined as the difference between the current motion vector and the prediction of the current motion vector. The prediction of the current motion vector can be inferred from the motion vectors of neighboring coding blocks that are already coded (or decoded). For coding efficiency, the corresponding differential motion vector is coded into bit-stream.

The differential motion vector reflects how different the current motion vector is from its neighboring motion vectors. Thus, it can be directly used in the motion vector filtering process. For example, if the difference reaches a certain threshold Tₘᵥ, the motion vector is excluded. Assuming the differential motion vector of the current coding block is (Δdₓ, Δd_{y}), then the following condition can be used in the filtering process:
|Δdₓ|+|Δd_{y}|<Tₘᵥ
If a differential motion vector does not meet the above condition, the corresponding motion vector is excluded from the update operation. It should be noted that the above condition is only an example. Other conditions can also be derived and used. For instance, the condition can be
max(|Δdₓ|, |Δd_{y}|)<Tₘᵥ.
Here max is an operation that returns the maximum value among a set of given values.

Since the prediction of the current motion vector is inferred only from the motion vectors of the neighboring coding blocks that are already coded (or decoded), it is also possible to check the motion vectors of more neighboring blocks regardless of their coding order relative to the current block. To carry out the filtering, one example is to consider the four neighboring blocks that are above, below, left of and right of the current block. The average of the four motion vectors associated with the four neighboring blocks is calculated and compared with the motion vector of the current block. Again, the conditions mentioned above can be used to measure the difference of the average motion vector and the current motion vector. If the difference reaches a certain threshold, the current motion vector is excluded from update operation.

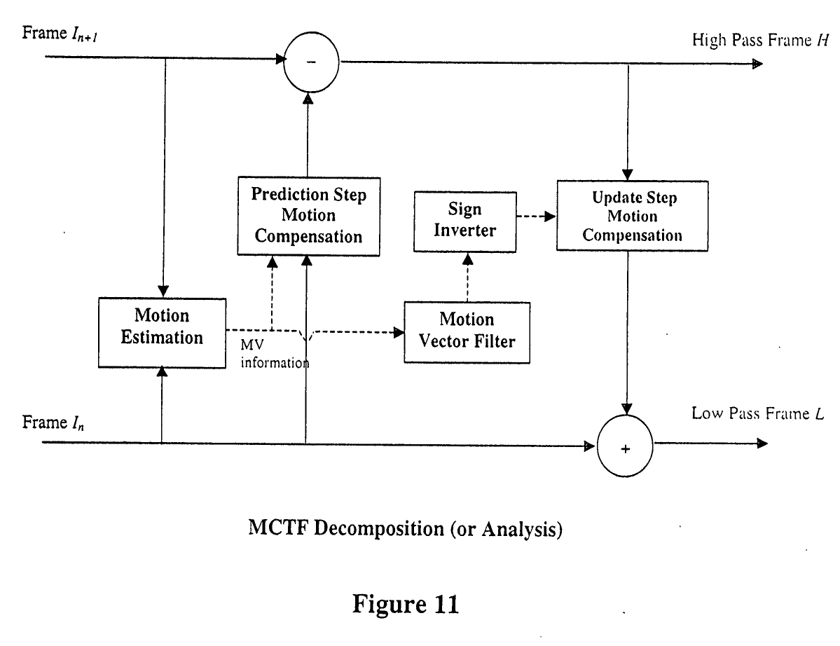

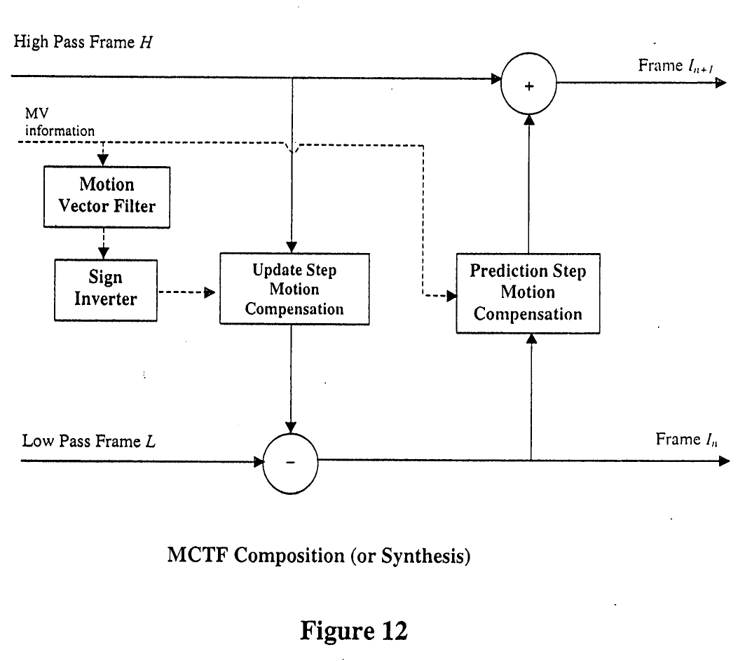

By removing some of the motion vectors from the update step operation, such a filtering process can further reduce the update step computation complexity. With a motion vector filter module, the MCTF decomposition and composition processes are shown in FIGS. 11 and 12, respectively, according to one embodiment of the present invention.

FIG. 11 is a block diagram showing the MCTF decomposition process, according to one embodiment of the present invention. The process includes a prediction step and an update step. In FIG. 11, Motion Estimation module and Prediction Step Motion Compensation module are used in the prediction step. Other modules are used in the update step. Motion vectors from Motion Estimation module are also used in the update step to derive motion vectors used for the update step, which is done in Sign Inverter via the Motion Vector Filter. As shown, motion compensation process is performed in both the prediction step and the update step.

FIG. 12 is a block diagram showing the MCTF composition process, according to one embodiment of the present invention. Based on received and decoded motion vector information, update motion vectors are derived in the Sign Inverter via a Motion Vector Filter. Then the same motion compensation processes as that in MCTF decomposition process are performed. Compared with FIG. 11, it can be seen the MCTF composition is the reverse process of MCTF decomposition. Specifically, the update operation includes a motion-compensated prediction using the received prediction residue, macroblock mode and the reverse direction of the received motion-vectors as illustrated in FIGS. 10 and 12. The prediction operation includes motion-compensated prediction with respect to the output of the update step, the received motion-vectors, and macroblock modes.

Adaptive Interpolation for Update Step Based on Prediction Residue Energy Level

In the present invention, an adaptive filter is used in the interpolating prediction residue block for the update operation. The adaptive filter is an adaptive combination of a shorter filter (e.g. bilinear filter) and a longer filter (e.g. 4-tap filter). Switching between the short filter and the long filter can be based on a final weight factor of each 4×4 block. The final weight factor is determined based on the prediction residue energy level of the block as well as the reliability of the update motion vector derived for the block adopted for interpolation in the update process with slight modification. Energy estimation and interpolation are performed on the whole coding block regardless of its size. Interpolation on a larger block means less overall computation because more intermediate results can be shared in the process.

Energy estimation can be carried out in different methods. One method is to use the average squared pixel value of the block as the energy level. If the mean value of a prediction residue block is assumed to be zero, the average squared pixel value of the block is equivalent to the variance of the block. In one embodiment of the present invention, a different filter from a filter set is selected in interpolating the block based on the calculated energy level. Blocks with a lower energy level have relatively smaller prediction residue, which also indicates that motion vectors associated with these blocks are relatively more reliable. When choosing the interpolation filter, it is preferable to use the long filter for interpolation of these blocks because they are more important in maintaining the coding performance. For blocks with higher energy levels, however, the short filter can be used.

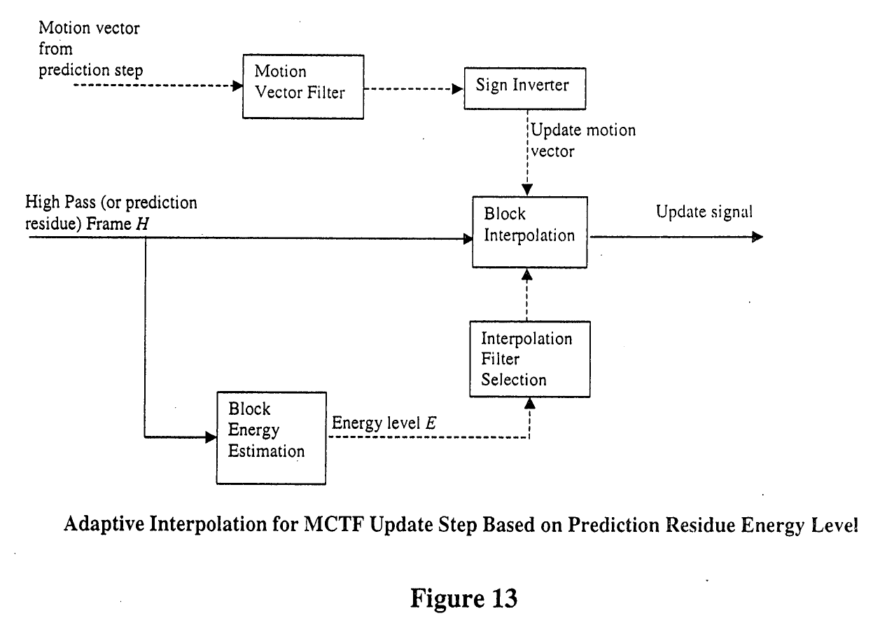

Taking FIG. 6 as an example, in order to update block A′ₙ, prediction residue at block B′ₙ₊₁ needs to be interpolated. To select the interpolation filter, the prediction residue energy level of block Bₙ₊₁ is calculated. For illustration purposes, assume the energy level E is normalized and is in the range of [0, 1]. The bigger the value of E, the higher the block energy level is. The energy level is then compared with a predetermined threshold Tₑ. The adaptive interpolation mechanism is based on the condition that if E<Tₑ, the long filter is used for interpolation at block B′ₙ₊₁. Otherwise, the short filter is used. Threshold Tₑ can be determined through testing, for example. When Tₑ is high, more blocks are interpolated with the long filter. When Tₑ is low, the short filter is more often used. The block diagram of such adaptive interpolation for MCTF update step is shown in FIG. 13.

FIG. 13 shows the process for adaptive interpolation for MCFT update step based on the prediction residue energy level, according to one embodiment of the present invention. As shown, the energy level is obtained from Block Energy Estimation module. Interpolation Filter Selection module makes filter selection decision based on the energy level. Block Interpolation module performs interpolation using selected filter on prediction residue block and the updated motion vector obtained from the Sign Inverter via the Motion Vector Filter based on the motion vectors from the prediction step. The interpolated result is then used for motion compensation in the update step.

Adaptive Threshold for Controlling Update Signal Strength

In the present invention, a threshold is adaptively determined for each coding block and used to limit the maximum amplitude of update signal for the block. Since the threshold values are adaptively determined in the coding process, there is no need to save them in coded bitstream.

In the example as shown in FIG. 6, assume that the interpolated prediction residue at block B′ₙ₊₁ is U(i,j), where (i,j) represent coordinates and (i,j)εB′ₙ₊₁. Assume the threshold determined for the block is Tₘ(Tₘ>0). The operation of limiting the maximum amplitude of update signal can be expressed as follows:
U(ij)=min(Tₘ, max(−Tₘ, U(ij)))
In the above equation, max and min are operations that return the maximum and minimum value respectively among a set of given values.

There are different ways in determining the threshold value for each coding block. One way is to determine the threshold value based on the energy level of the block. Since the energy level of the block is already calculated in selecting interpolation filter, it can be re-used in this step.

As mentioned above, blocks with lower energy levels have relatively smaller prediction residue, which also indicates that motion vectors associated with these blocks are relatively more reliable. In this case, a higher threshold value should be assigned so that most prediction residue values in the block can be used directly for update without being capped by the threshold. On the other hand, for block with higher energy level, since motion vectors of the block may not be reliable, a relatively lower threshold should be assigned to avoid introducing visual artifacts.

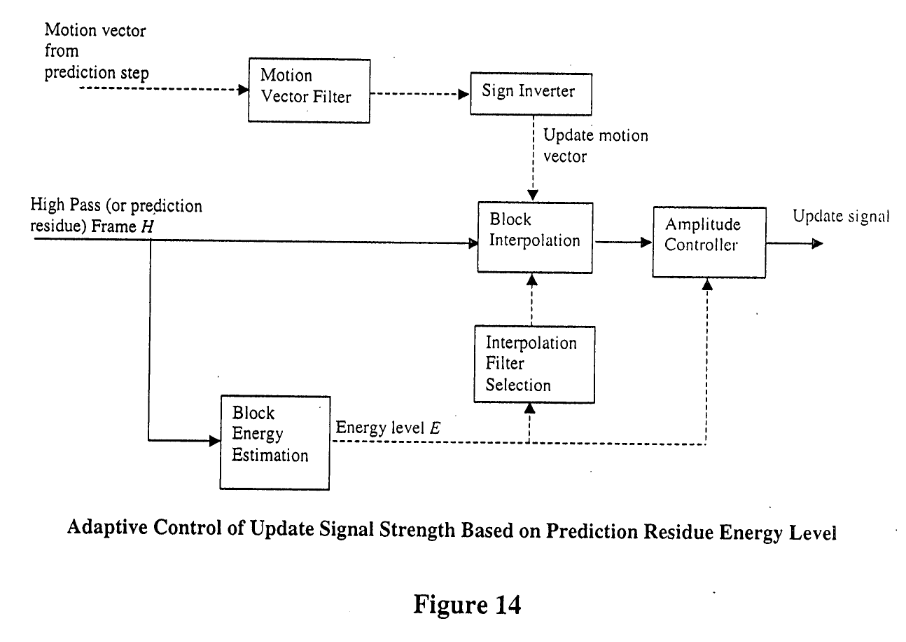

One example of relating the threshold value to the prediction residue energy level can be given as follows:
Tₘ=C₁*(1−E)+D₁
In the above equation, E represents the prediction residue energy level of the block. As explained earlier, it is assumed that E is normalized and is in the range of [0, 1]. C₁ and D₁ are two constants and their values can be determined through tests. For example, with C₁₌16 and D₁=4, the corresponding threshold values are found to be appropriate with good coding performance. According to the above equation, the higher the energy level of the block, the lower a threshold value is used. The block diagram of such an adaptive control process on update signal strength is shown in FIG. 14.

FIG. 14 shows the process for adaptive control of update signal strength for MCFT update step based on prediction residue energy level. In FIG. 14, Interpolation Filter Selection makes filter selection decision based on the energy level obtained from the Block Energy Estimation module. Interpolation is performed in Block Interpolation module based on the updated motion vectors obtained from the Sign Inverter using the motion vectors from the prediction step filtered through the Motion Vector Filter. After the amplitude of the updated signal strength is controlled by Amplitude Control module, the result is used for motion compensation.

In another embodiment of the present invention, the threshold value is adaptively determined based on a block-matching factor. The block-matching factor is an indicator indicating how well the block is matched or predicted in the prediction step. If the block is matched well, it implies that the corresponding motion vector is more reliable. In this case, a higher threshold value may be used in the update step. Otherwise, a lower threshold value should be used.

To obtain the block-matching factor, one method is to check the ratio of the variance of the corresponding block to be updated versus the energy level of the prediction residue block. For the example shown in FIG. 6, the energy level of block Bₙ₊₁ and the variance of block A′ₙ are calculated. The ratio of the variance value versus the energy level can be used as a block-matching factor. If the ratio is large, it can be assumed that the block matching in prediction step is relatively good. The case in which the prediction residue block Bₙ₊₁ has an energy level of zero can be excluded.

Another method in obtaining a block-matching factor is to perform a high pass filtering operation on the block to be updated. Then the amplitude (i.e. absolute value) of each filtered pixel in the block is compared against the amplitude of the corresponding prediction residue pixel. It can be assumed that the prediction residue pixel should have smaller amplitude than the corresponding filtered pixel if the block is well matched in the prediction step. The percentage of prediction residue pixels in the block having smaller amplitude than corresponding filtered pixels can be used as block-matching factor. The percentage may be a good indication that the block is well-matched in the prediction step.

The high pass filtering operation can be general and is not limited to one method. One example is to apply a 2-D filter as follows:

| | | |
|---|---|---|
| 0 | −¼ | 0 |
| −¼ | 1 | −¼ |
| 0 | −¼ | 0 |

Another example is to calculate the value difference between the current pixel and its four nearest neighboring pixels. The maximum difference among the four differential values can be used as the high pass filtered value for the current pixel.

Besides the above two examples of high pass filter, other high pass filters can also be used.

Once the block-matching factor is obtained, a threshold value can be derived from the block-matching factor. Assume the block-matching factor is M and it is a normalized value in the range of [0, 1]. An example of deriving the threshold value from the block matching factor can be given as follows:
Tₘ=C₂*M+D₂
In the above equation, C₂ and D₂ are two constants and their values can be determined through tests. For example, C₂=16 and D₂=4 may be appropriate values. According to the above equation, if a block is matched well and M has a relatively large value, Tₘ also has a relatively large value.

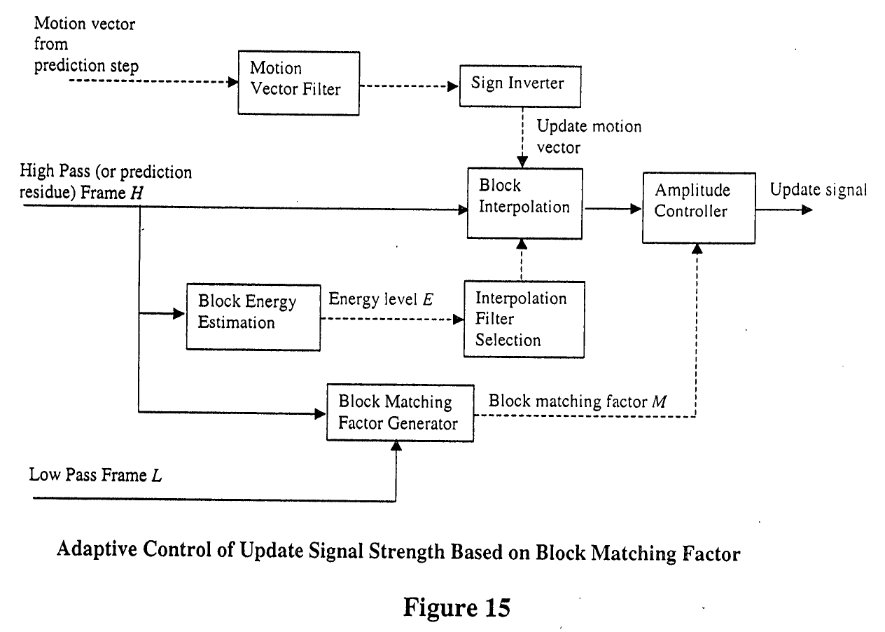

The process of adaptive control of update signal strength based on block-matching factor is shown in FIG. 15. FIG. 15 shows the process for adaptive control of update signal strength for MCFT update step based on the block-matching factor. In FIG. 15, Interpolation Filter Selection makes filter selection decision based on the energy level obtained from the Block Energy Estimation module. Interpolation is performed in Block Interpolation module based on the updated motion vectors obtained from the Sign Inverter using the motion vectors from the prediction step filtered through the Motion Vector Filter. After the amplitude of the updated signal strength is controlled by Amplitude Control module, the result is used for motion compensation. As shown in FIG. 15, the block-matching factor obtained from the Block Matching Factor Generator module is also used for controlling the update signal strength.

In summary, the present invention provides a method, an apparatus and a software application product for performing the update step in motion compensated temporal filtering for video coding.

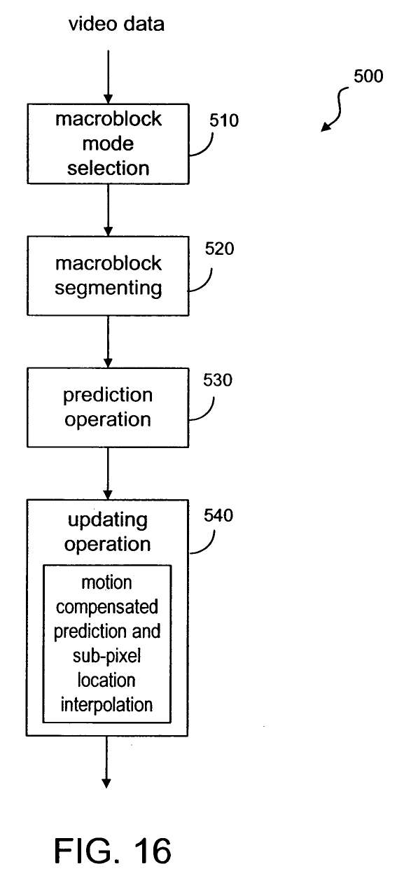

The update operation is performed according to coding blocks in the prediction residue frame. Depending on macroblock mode in the prediction step, a coding block can have different sizes. In encoding, the method is illustrated in FIG. 16. As shown in flowchart 500 in FIG. 16, as the encoding module receives video data representing of a digital video sequence of video frames, it starts at step 510 to select a macroblock mode so that a macroblock formed from the pixels in a video frame can be segmented at step 520 into a number of blocks as specified by the selected macroblock mode. At step 530, a prediction operation is performed on the blocks based on motion compensated prediction with respect to a reference video frame and motion vectors so as to provide corresponding blocks of prediction residue. At step 540, the video reference frame is updated based on motion compensated prediction with respect to the blocks of prediction residue and the macroblock mode and on the reverse direction of the motion vector. The sub-pixel locations of the blocks of prediction residue are interpolated using an interpolation filter adaptively selected between a short filter and a long filter, for example. The selection of the interpolation filter can be partially based on the energy level of the prediction residue in the block. Furthermore, the amplitude of the update signal can be limited to a threshold which is determined based on the energy level of the prediction residue and/or the block matching factor of the block. The update operation may be skipped if the difference between the motion vectors of the predicted block and the motion vectors of the neighboring blocks is greater than a threshold.

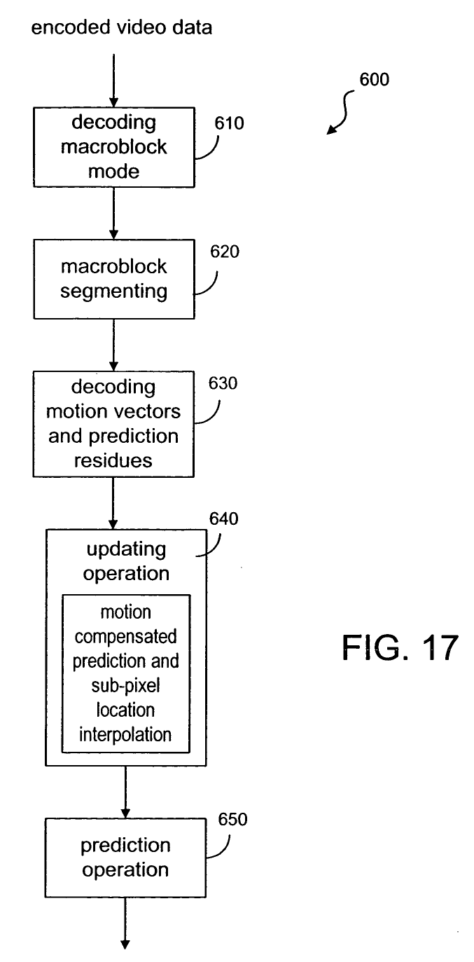

In decoding, the method is illustrated in FIG. 17. As shown in the flowchart 600 in FIG. 17, as the decoding module receives an encoded video data representing an encoded video sequence of video frames, it starts at step 610 to decode a macroblock mode so that a macroblock formed from the pixels in the video frame can be segmented at step 620 into a number of blocks as specified by the selected macroblock mode. At step 630, the decoding module decodes the motion vectors and prediction residues of the blocks. At step 640, a reference frame of the blocks is updated based on motion compensated prediction with respect to the prediction residues of the blocks according to the macroblock mode and the reverse direction of the motion vectors. The sub-pixel locations of the blocks of prediction residue may be interpolated using an interpolation filter adaptively selected between a short filter and a long filter, for example. The selection of the interpolation filter can be partially based on the energy level of the prediction residue in the block. Furthermore, the amplitude of the update signal can be limited to a threshold which is determined based on the energy level of the prediction residue and/or the block matching factor of the block. This update operation may be skipped if the difference between the received motion vectors of the current block and the motion vectors of the neighboring blocks is greater than a threshold. At step 650, a prediction operation is performed on the blocks based on motion compensated prediction with respect to the updated reference video frame and motion vectors.

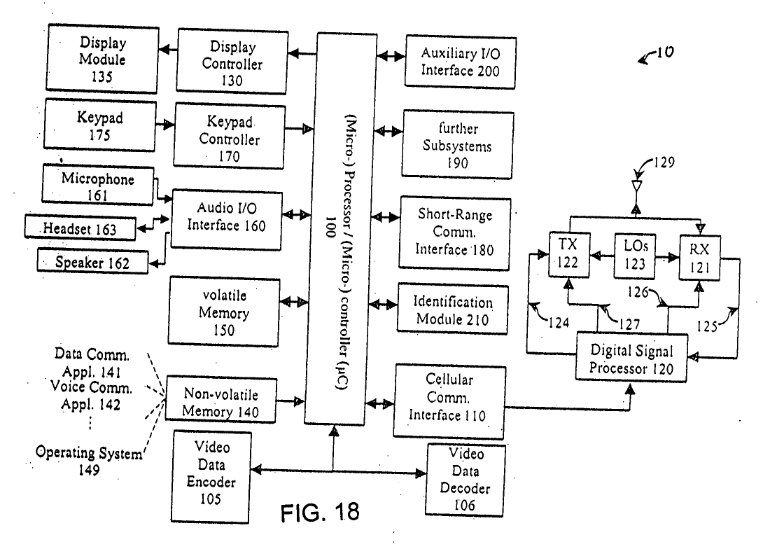

Referring now to FIG. 18. FIG. 18 shows an electronic device that equips at least one of the MCTF encoding module and the MCTF decoding module as shown in FIGS. 9 and 10. According to one embodiment of the present invention, the electronic device is a mobile terminal. The mobile device 10 shown in FIG. 18 is capable of cellular data and voice communications. It should be noted that the present invention is not limited to this specific embodiment, which represents one of a multiplicity of different embodiments. The mobile device 10 includes a (main) microprocessor or micro-controller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 18 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 10 depicted in FIG. 18 is used with the antenna 129 as or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 10 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/micro-controller (μC) 110, which may also be designated as a device platform microprocessor, manages the functions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 18, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 10 is equipped with a module for scalable encoding 105 and scalable decoding 106 of video data according to the inventive operation of the present invention. By means of the CPU 100 said modules 105, 106 may individually be used. However, the device 10 is adapted to perform video data encoding or decoding respectively. Said video data may be received by means of the communication modules of the device or it also may be stored within any imaginable storage means within the device 10. Video data can be conveyed in a bitstream between the device 10 and another electronic device in a communications network.

Although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of encoding a digital video sequence using motion compensated temporal filtering for providing a bitstream having video data representative of encoded video sequence, the digital video sequence comprising a plurality of frames, wherein each frame comprises an array of pixels which can be divided into a plurality of macroblocks, said method comprising:
for a macroblock,
selecting a macroblock mode;
segmenting the macroblock into a number of blocks based on the macroblock mode;
performing a prediction operation on said blocks, based on motion compensated prediction with respect to a reference video frame and motion vectors, for providing corresponding blocks of prediction residues; and
updating said video reference frame based on motion compensated prediction with respect to said blocks of prediction residues and the macroblock mode, and further based on a reverse direction of said motion vectors.

2. The method of claim 1, wherein each of the blocks is associated with one of the motion vectors, said method further comprising:
comparing the motion vector associated with one of the blocks with the motion vectors associated with adjacent blocks for providing a differential vector of said one block; and
skipping said updating with respect to said one block if the differential vector is greater than a predetermined value.

3. The method of claim 1, wherein the blocks of prediction residue form a prediction residue frame, said updating comprising:
interpolating sub-pixel locations of said blocks of prediction residues in the prediction residue frame based on an interpolation filter.

4. The method of claim 3, wherein the interpolation filter is adaptively selected from a plurality of filters comprising at least a shorter filter and a longer filter.

5. The method of claim 4, wherein said selection is at least partially based on an energy level of prediction residue in said block.

6. The method of claim 1, further comprising:
limiting amplitude of the prediction residue of a block in said updating to a threshold determined at least based on an energy level of the prediction residue in said block.

7. The method of claim 1, further comprising:
limiting amplitude of the prediction residue of a block in said updating to a threshold determined at least based on a block matching factor of said block.

8. A method of decoding a digital video sequence from video data in a bitstream representative of an encoded video sequence, the encoded video sequence comprising a number of frames, each frame comprising an array of pixels, wherein the pixels in each frame can be divided into a plurality of macroblocks, said method comprising:
for a macroblock,
obtaining a macroblock mode;
segmenting the macroblock into a number of blocks based on the macroblock mode;
decoding motion vectors and prediction residues of the blocks;
performing an update operation on a reference video frame of said blocks, based on motion compensated prediction with respect to the prediction residues of said blocks based on said macroblock mode and a reverse direction of the motion vectors; and
performing a prediction operation on said blocks based on motion compensated prediction with respect to updated reference video frame and the motion vectors.

9. The method of claim 8, wherein each of the blocks is associated with one of the motion vectors, said method further comprising:
comparing the motion vector associated with one of the blocks with the motion vectors associated with adjacent blocks for providing a differential vector of said one block; and
skipping said updating with respect to the said one block if the differential vector is greater than a predetermined value.

10. The method of claim 8, wherein the blocks of prediction residues form a prediction residue frame, said updating comprising:
interpolating sub-pixel locations of said blocks of prediction residues in the prediction residue frame based on an interpolation filter.

11. The method of claim 10, wherein the interpolation filter is adaptively selected from a plurality of filters comprising at least a shorter filter and a longer filter.

12. The method of claim 11, wherein said selection is at least partially based on an energy level of prediction residue in said block.

13. The method of claim 8, further comprising:
limiting amplitude of the prediction residue of a block in said updating to a threshold determined at least based on an energy level of the prediction residue in said block.

14. The method of claim 8, further comprising:
limiting amplitude of the prediction residue of a block in said updating to a threshold determined at least based on a block matching factor of said block.

15. An encoding module for use in encoding a digital video sequence using motion compensated temporal filtering for providing a bitstream having video data representative of encoded video sequence, the digital video sequence comprising a plurality of frames, wherein each frame comprises an array of pixels which can be divided into a plurality of macroblocks, said encoding module comprising:
a mode decision module configured for selecting, for a macroblock, a macroblock mode so as to segment the macroblock into a number of blocks based on the macroblock mode;
a prediction module for performing a prediction operation on said blocks, based on motion compensated prediction with respect to a reference video frame and motion vectors, for providing corresponding blocks of prediction residues; and
an updating module for updating said video reference frame based on motion compensated prediction with respect to said blocks of prediction residues and the macroblock mode, and further based on a reverse direction of said motion vectors.

16. The encoding module of claim 15, wherein each of the blocks is associated with one of the motion vectors, said encoding module further comprising:
a processor for comparing the motion vector associated with one of the blocks with the motion vectors associated with adjacent blocks for providing a differential vector of said one block; such that when the differential vector is greater than a predetermined value, the updating module is configured to skip said updating with respect to said one block if the differential vector is greater than a predetermined value.

17. The encoding module of claim 15, wherein the blocks of prediction residue form a prediction residue frame, said encoding module further comprising:
an interpolation filter module for interpolating sub-pixel locations of said blocks of prediction residues in the prediction residue frame based on an interpolation filter.

18. The encoding module of claim 17, wherein the interpolation filter is adaptively selected from a plurality of filters comprising at least a shorter filter and a longer filter.

19. The encoding module of claim 18, wherein said selection is at least partially based on an energy level of prediction residue in said block.

20. The encoding module of claim 15, further comprising:
an amplitude control module for limiting amplitude of the prediction residue of a block in said updating to a threshold determined at least based on an energy level of the prediction residue in said block.

21. The encoding module of claim 15, further comprising:
an amplitude control module for limiting amplitude of the prediction residue of a block in said updating to a threshold determined at least based on a block matching factor of said block.

22. A decoding module for use in decoding a digital video sequence from video data in a bitstream representative of an encoded video sequence, the encoded video sequence comprising a number of frames, each frame comprising an array of pixels, wherein the pixels in each frame can be divided into a plurality of macroblocks, said decoding module comprising:
a first decoding sub-module, responsive to the video data, for decoding a macroblock mode so as to segment the macroblock into a number of blocks based on the macroblock mode;
a second decoding sub-module for decoding motion vectors and prediction residues of the blocks;
an updating module for performing an update operation on a reference video frame of said blocks, based on motion compensated prediction with respect to the prediction residues of said blocks based on said macroblock mode and a reverse direction of the motion vectors; and
a prediction module for performing a prediction operation on said blocks based on motion compensated prediction with respect to updated reference video frame and the motion vectors.

23. The decoding module of claim 22, wherein each of the blocks is associated with one of the motion vectors, said decoding module further comprising:
a processor for comparing the motion vector associated with one of the blocks with the motion vectors associated with adjacent blocks for providing a differential vector of said one block; such that when the differential vector is greater than a predetermined value, the updating module is configured to skip said updating with respect to the said one block.

24. The decoding module of claim 22, wherein the blocks of prediction residues form a prediction residue frame, said decoding module further comprising:
an interpolation filter module for interpolating sub-pixel locations of said blocks of prediction residues in the prediction residue frame based on an interpolation filter.

25. The decoding module of claim 24, wherein the interpolation filter is adaptively selected from a plurality of filters comprising at least a shorter filter and a longer filter.

26. The decoding module of claim 25, wherein said selection is at least partially based on an energy level of prediction residue in said block.

27. The decoding module of claim 22, further comprising:
an amplitude control module for limiting amplitude of the prediction residue of a block in said updating to a threshold determined at least based on an energy level of the prediction residue in said block.

28. The decoding module of claim 22, further comprising:
an amplitude control module for limiting amplitude of the prediction residue of a block in said updating to a threshold determined at least based on a block matching factor of said block.

29. A software application product, comprising a storage medium having a software application for encoding a digital video sequence using motion compensated temporal filtering for providing a bitstream having video data representative of encoded video sequence, the digital video sequence comprising a plurality of frames, wherein each frame comprises an array of pixels which can be divided into a plurality of macroblocks, said software application comprising:
program code for selecting a macroblock mode for a macroblock;
program code for segmenting the macroblock into a number of blocks based on the macroblock mode;
program code for performing a prediction operation on said blocks, based on motion compensated prediction with respect to a reference video frame and motion vectors, for providing corresponding blocks of prediction residues; and
program code for updating said video reference frame based on motion compensated prediction with respect to said blocks of prediction residues and the macroblock mode, and further based on a reverse direction of said motion vectors.

30. The software application product of claim 29, wherein each of the blocks is associated with one of the motion vectors, said software application further comprising:
program code for comparing the motion vector associated with one of the blocks with the motion vectors associated with adjacent blocks for providing a differential vector of said one block and, if the differential vector is greater than a predetermined value, skipping said updating with respect to said one block.

31. A software application product, comprising a storage medium having a software application for decoding a digital video sequence from video data in a bitstream representative of an encoded video sequence, the encoded video sequence comprising a number of frames, each frame comprising an array of pixels, wherein the pixels in each frame can be divided into a plurality of macroblocks, said software application comprising:
program code for obtaining a macroblock mode for a macroblock from the video data;
program code for segmenting the macroblock into a number of blocks based on the macroblock mode;
program code for decoding motion vectors and prediction residues of the blocks;
program code for performing an update operation on a reference video frame of said blocks, based on motion compensated prediction with respect to the prediction residues of said blocks based on said macroblock mode and a reverse direction of the motion vectors; and
program code for performing a prediction operation on said blocks based on motion compensated prediction with respect to updated reference video frame and the motion vectors.

32. The software application product of claim 31, wherein each of the blocks is associated with one of the motion vectors, said software application further comprising:
program code for comparing the motion vector associated with one of the blocks with the motion vectors associated with adjacent blocks for providing a differential vector of said one block and, if the differential vector is greater than a predetermined value, skipping said updating with respect to the said one block

33. An electronic device configured to acquire a digital video sequence, comprising:
an encoding module for encoding the digital video sequence using motion compensated temporal filtering for providing a bitstream having video data representative of encoded video sequence, the digital video sequence comprising a plurality of frames, wherein each frame comprises an array of pixels which can be divided into a plurality of macroblocks, said encoding module comprising:
a mode decision module configured for selecting, for a macroblock, a macroblock mode so as to segment the macroblock into a number of blocks based on the macroblock mode;
a prediction module for performing a prediction operation on said blocks, based on motion compensated prediction with respect to a reference video frame and motion vectors, for providing corresponding blocks of prediction residues; and
an updating module for updating said video reference frame based on motion compensated prediction with respect to said blocks of prediction residues and the macroblock mode, and further based on a reverse direction of said motion vectors.

34. The electronic device of claim 33, further configured to receive video data representation of an encoded video sequence, the mobile terminal further comprising:
a decoding module for decoding the encoded video sequence from video data, the encoded video sequence comprising a number of frames, each frame comprising an array of pixels, wherein the pixels in each frame can be divided into a plurality of macroblocks, said decoding module comprising:
a first decoding sub-module, responsive to the video data, for decoding a macroblock mode so as to segment the macroblock into a number of blocks based on the macroblock mode;
a second decoding sub-module for decoding motion vectors and prediction residues of the blocks;
an updating module for performing an update operation on a reference video frame of said blocks, based on motion compensated prediction with respect to the prediction residues of said blocks based on said macroblock mode and a reverse direction of the motion vectors; and
a prediction module for performing a prediction operation on said blocks based on motion compensated prediction with respect to updated reference video frame and the motion vectors.

35. An encoding module for use in encoding a digital video sequence using motion compensated temporal filtering for providing a bitstream having video data representative of encoded video sequence, the digital video sequence comprising a plurality of frames, wherein each frame comprises an array of pixels which can be divided into a plurality of macroblocks, said encoding module comprising:
means for selecting, for a macroblock, a macroblock mode so as to segment the macroblock into a number of blocks based on the macroblock mode;
means for performing a prediction operation on said blocks, based on motion compensated prediction with respect to a reference video frame and motion vectors, for providing corresponding blocks of prediction residues; and
means for updating said video reference frame based on motion compensated prediction with respect to said blocks of prediction residues and the macroblock mode, and further based on a reverse direction of said motion vectors.

36. The encoding module of claim 35, wherein each of the blocks is associated with one of the motion vectors, said encoding module further comprising:
means for comparing the motion vector associated with one of the blocks with the motion vectors associated with adjacent blocks for providing a differential vector of said one block; such that when the differential vector is greater than a predetermined value, the updating module is configured to skip said updating with respect to said one block if the differential vector is greater than a predetermined value.

37. A decoding module for use in decoding a digital video sequence from video data in a bitstream representative of an encoded video sequence, the encoded video sequence comprising a number of frames, each frame comprising an array of pixels, wherein the pixels in each frame can be divided into a plurality of macroblocks, said decoding module comprising:
means, responsive to the video data, for decoding a macroblock mode so as to segment the macroblock into a number of blocks based on the macroblock mode;
means for decoding motion vectors and prediction residues of the blocks;
means for performing an update operation on a reference video frame of said blocks, based on motion compensated prediction with respect to the prediction residues of said blocks based on said macroblock mode and a reverse direction of the motion vectors; and
means for performing a prediction operation on said blocks based on motion compensated prediction with respect to updated reference video frame and the motion vectors.

38. The decoding module of claim 37, wherein each of the blocks is associated with one of the motion vectors, said decoding module further comprising:
means for comparing the motion vector associated with one of the blocks with the motion vectors associated with adjacent blocks for providing a differential vector of said one block; such that when the differential vector is greater than a predetermined value, the updating module is configured to skip said updating with respect to the said one block.
